(19) United States
(12) Patent Application Publication
(10) Pub. No.: US 2020/0121124 A1
(43) Pub. Date: Apr. 23, 2020

(54) CONTAINER AND METHOD FOR HEAT TREATMENT OF FOODSTUFFS

(71) Applicant: USER SOLUTION AS, Seim (NO)

(72) Inventors: Vegard Ertvaag, Lurevegen (NO); Thor Øyvind Rafto, Rådal (NO); Line Beate Ulstein, Rådal (NO)

(21) Appl. No.: 16/624,815

(22) PCT Filed: Jun. 13, 2018
(86) PCT No.: PCT/NO2018/050154

§ 371 Date: Dec. 19, 2019

(30) Foreign Application Priority Data
Jun. 26, 2017 (NO) 20171043

(51) Int. Cl. A47J 36/20; A47J 36/18; A47J 27/10; A23L 7/10

(52) U.S. Cl. CPC A47J 36/20; A47J 36/18; A23V 2002/00; A23L 7/1975; A47J 2203/00; A47J 27/10

(57) ABSTRACT

Described is a container for heat treatment of foodstuff in a liquid in a pot and it is characterised by a manufactured cup (10) with a base and a wall (24) comprising through going holes (70) for the free flow of liquid (fluid) into and out of the inner volume of the cup, and the cup wall (24) comprises at least one first set of marks (A1-A4) and a second set of marks (B1-B4), where the first set of marks (A1-A4) is set up in a lower part of the cup wall to show a predetermined amount of foodstuff in the cup (10) while the second set of marks (B1-B4) is set up above the first set of marks (A1-A4) to show the in-cup level of liquid supplied, where the ratio of the first set of marks (A1-A4) to the second set of marks (B1-B4) in the cup wall (24) is predetermined based on which foodstuff that shall be heat treated. A method for cooking/simmering rice is also disclosed, by the application of the inventive container.

### FIELD OF THE INVENTION

The present invention relates to a container for heat treatment of a foodstuff in a liquid (such as water) in a pot, as shown in the preamble of claim 1. Furthermore, the invention relates to a method as given in claim 17, for the cooking of a food product where said container is used.

### BACKGROUND OF THE INVENTION

It is well-known to boil (simmer) vegetables, pasta, rice and other food products on a heat source (oven-stove) in a pot or container with a perforated base which is set up to be placed in a larger pot which is then filled with an adequate amount of liquid/water, and where possibly a lid is placed on the pot. The heat from the cooker is turned on and the water that is boiled evaporates so that the food product is boiled while submerged in the water and the food product is cooked ready for serving. During such a cooking process of, for example, rice, the rice absorbs water and swells up. When rice is boiled in a regular pot where the base it not perforated, it is assumed that the required volume of water is twice that of the volume of the rice. When water and rice are properly measured, the water is almost completely absorbed, and the cooked rice can be put on a serving plate without much water running off. The term “to simmer” means that after the water has boiled off, the heat on the plate is turned down and the water temperature is kept at or just below the boiling point until the cooking is complete.

Concerning rice and pasta foods, so-called “boil-in-bags” are a common commodity. An appropriate serving of rice, which is pre-cooked and dried, is delivered packaged in a perforated bag in a dry state. During preparation, the entire bag is placed in water in a pot so that the water penetrates through the perforations. Since the rice is pre-cooked, it easily absorbs water, boils and swells up, and is ready for serving in a few minutes.

One disadvantage with this type of preparation is that one has to lift the bag out of the pot with one's fingers and that the bag must be cut with scissors or opened by tearing off a marked rip-edge at one end of the bag and poured into a bowl to be served at the table. This may cause burns to the fingers from the boiling water, and there can be a lot of spillage of rice which can stick to the fingers and the table/bench.

In the present invention, the term cup is used for such a container, while in the case of preparing rice it is described as a rice cup, rice dish or rice bowl.

### PRIOR ART

Concerning prior art, reference should be made to the following five publications mentioned below which describe cup constructions with perforations for free flow of liquid upon heat treatment in a pot. Chinese Patent Publications CN-2012/23277Y and CN-205286083U, British Patent GB-227190, and International Patent Applications WO 2017094244 and WO-2000/15089.

None of the publications shows measurement instructions for foodstuffs or liquid amounts, or a relationship between correlating volume of foodstuff and liquid level as envisaged by the present invention. According to the invention, the sets of marks include horizontal marks and/or perforations (holes) and there is a correlation between measured fluid level and volume of foodstuff that is constant between the different levels in each set.

### AIM OF THE INVENTION

It is an aim of the invention to provide a cup construction for heat treatment/boiling of food.

Furthermore, it is an aim to provide a new method of boiling/simmering food in a liquid (water) as mentioned above.

### SUMMARY OF THE INVENTION

According to the invention, the container is characterised by a manufactured cup with a base and a wall which is comprised of holes for the free flow of liquid (fluid) into and out of the inner volume of the cup, and the cup wall is comprised of, at least, one first set of marks and a second set of marks where the first set of marks is set up in a lower part of the cup wall to reveal a predetermined amount of foodstuffs in the cup while the second set of marks is set up above the first set of marks to reveal a cup level of fluid supplied, in that the ratio of the first set of marks to the second set of marks in the cup wall is predetermined based on which foodstuff is to be heat-prepared as indicated in the characteristic of claim 1.

According to a preferred embodiment, the first set of marks is grouped as sets with mutual spacing along the vertical of the cup wall, one set above the other, in that the lower mark indicates the level of one normal serving of measured amount of foodstuff placed in the cup, while a next overlying mark shows the level of two normal servings of foodstuffs in the cup, etc., and where the second set of marks for liquid level is grouped as sets with mutual distance along the vertical of the cup wall, one set over the other, in that the lowest mark shows the required liquid level for heat treatment of one normal serving of foodstuff in the cup while a next overlying mark shows the liquid level for heat treatment of two normal servings of foodstuff in the cup, etc.

Preferably, the ratio of the measured amounts which is defined by the measurement marks is constant and given by the type of foodstuff that shall be cooked.

Furthermore, when the cup is used to heat rice, it is preferable that the ratio between A1/B1=A2/B2=A3/B3=A4/B4 is approximately equal to 0.5 so that the volume of rice is half of the volume of water.

According to yet another preferred embodiment, the measurement marks are either engraved marks or punched marks such as straight horizontal lines on the cup wall or formed by sets of holes through the cup wall.

According to yet another preferred embodiment, the first set of labels for foodstuff is grouped as a set of holes mutually spaced apart along the vertical of the cup wall, one set above the other, in that a bottom set of holes shows the necessary amount of foodstuff for one normal serving in the cup while a next overlying set of holes indicates the amount for two normal servings of foodstuffs in the cup, etc.

Preferably, the bottom set of holes for showing liquid level consists of a single hole in the cup wall while the next set of holes for the liquid level consists of two holes in the cup wall etc. in that each hole has a circular, triangular, square, oval or teardrop-shaped cross section, or is in the form of a horizontal slit.

In particular, it is preferred that the second set of marks for liquid level is grouped as a set of holes mutually spaced along the vertical of the cup wall, one set above the other, in that a bottom set of holes shows the liquid level required for one normal serving of foodstuff in the cup, while a next overlying set of holes marks the level of fluid for the preparation of two normal servings of foodstuff in the cup, etc.

Preferably, the bottom set of holes for marking the liquid level consists of a single hole in the cup wall, while the next set of holes consists of two holes in the cup wall etc. in that each hole has a circular, triangular, square, oval or teardrop-shaped cross section, or is in the form of a lengthy slit.

According to yet another preferred embodiment there are more than two sets of groups with correlating marks, in that these groups of sets are set up with a mutual distance apart around the circumference of the cup, such as in each quadrant around the cup.

It is particularly preferred that there are several sets of serving markings for foodstuffs and associated sets of liquid level marking for the various types of foodstuffs to be heat-treated or variants of the same foodstuff such as rice, oats (for oatmeal), pasta, quinoa etc., or brown rice, sushi rice, white rice, etc., set up with mutual spacing apart from each other around the circumference of the cup.

Preferably, the cup is comprised of a detachable curved lid with a flat top side, where the lid turned around may act as a stable surface on which the cup is placed after heat treatment or as a serving plate for the foodstuff.

Furthermore, the cup may preferably be comprised of a base with one or more spacers below the base, such as beads or knobs, preferably three spacers are positioned at 60 degrees apart from each other around the circumference, to keep the underside of the cup at a suitable distance over the base of the boiler.

Furthermore, adjacent to each measurement mark, on the outside and/or the inside of the cup wall, there are more engraved or indented corresponding serving markings, in the form of numbers or symbols.

According to a preferred embodiment, the cup wall is comprised of at least one upwardly extending gripping handle for the manual guiding of the cup down into and up from the pot where the heat treatment is carried out.

According to yet another preferred embodiment, the cup is made of a transparent or translucent material such as plastic or glass so that the marks are visible through the cup wall.

These preferred embodiments of the container are defined in the dependent claims 2-17.

The method of cooking/simmering rice according to the invention is characterised in that

1) rice is filled into the cup up to the mark (hole) for the desired number of servings

2) the rice is rinsed thoroughly in cold water before the cup is put up in a pot which holds the cup

3) the pot is filled with water up to the watermark for the corresponding number of rice servings,

4) the lid is placed on the cup and the heating is started,

5) when the rice is cooked, the cup is lifted from the pot and any water may drain off,

6) the lid is lifted from the cup, it is turned around and the cup is placed on the turned lid and

7) the rice is served directly from the cup,

as shown in the appended claim 17.

### DESCRIPTION OF FIGURES

Embodiments of the present invention shall now be described in more detail with reference to the accompanying figures, in which:

FIG. 1 shows an above perspective view of the cup.

FIG. 2 shows a side view of the cup.

FIG. 3 shows a side view of the cup with a lid.

FIG. 4 shows a side view of the cup where the lid is flipped and used as a dish (a bowl) that can receive water which drips or flows through the bottom holes in the cup and down to the dish.

FIG. 5 shows a section partially in outline of the cup where the marks are shown as lines.

FIG. 6 shows a seven-stage usage sequence for how a given amount of rice is boiled in a given amount of water, indicated as perforations in the cup wall, to a ready-to-serve serving of rice.

The cup can be placed directly on the table standing on the dish which was initially used as a lid during the cooking.

### DESCRIPTION OF PREFERRED EMBODIMENTS OF THE INVENTION

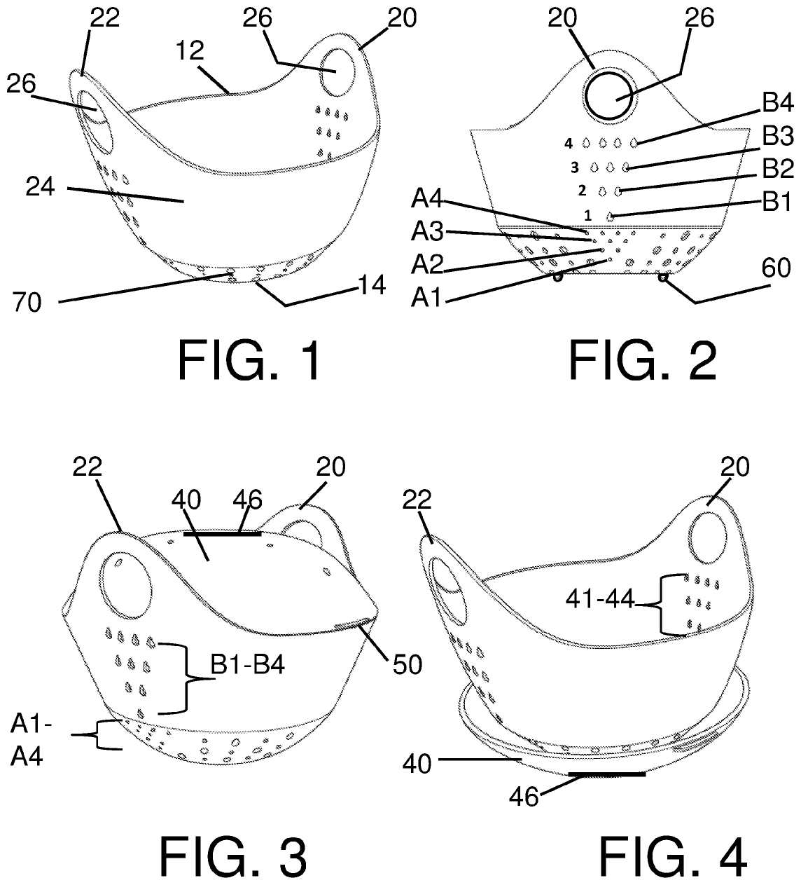

Initially, reference is made to FIGS. 1 and 2, which show the cup in a perspective and a side view.

The cup 10 has a regular cup shape which preferably tapers (it may also have straight walls) from the top 12 downwards to a flat base 14 intended to stand on a surface with a number of holes or perforations 70 for the free flow of liquid through the cup. Underneath the cup there are one or more spacers 60 such as knobs or beads which form a distance from the base of the cup to the surface, preferably three knobs at 60 degrees to each other to hold the base of the cup at a distance above the base of the pot during cooking.

The cup is intended to stand in a pot 50 with water which is being heated up and since it shall be lifted out of the water with one's hands, it is comprised of one or two upwardly extending handles 20 and 22, respectively, which the user seizes with their hands (through opening 26) when the cup is placed into the water and when it is to be taken out of the water. They protrude as a continuation of the cup wall 24. In principle, it is sufficient that the cup has a single handle 20 of this type so that the cup can be lifted up from the pot with one hand. FIG. 6, (point 2) shows that the two handles 20, 22 protrude slightly above the upper edge 54 of the pot 50. This reduces the risk of the user burning his fingers from the hot rising steam or a hot handle when grasping the handles 20/22 to lift the cup. The cup has internal and external marks indicating the amount of foodstuff and the corresponding amount of liquid for different normal servings. This relationship is given depending on which foodstuff the mark indicates. For example, the ratio of amount of rice to water to boil rice is 1:2. That is to say, to cook 1 dl of rice you need 2 dl of water. The mark for the liquid volume recommendation for a normal serving of rice will thus correspond to twice the volume of what the label for a normal serving of rice will show.

Similarly, the ratio of amount of quinoa to amount of water that is required for preparation of quinoa is 1:2. Another example is the preparation of oatmeal, where it takes about three times as much liquid (water, milk or a combination of both) as the volume of oatmeal, and the ratio is then 1:3.

Measurement of Water Vs. Rice Using Visual Marking.

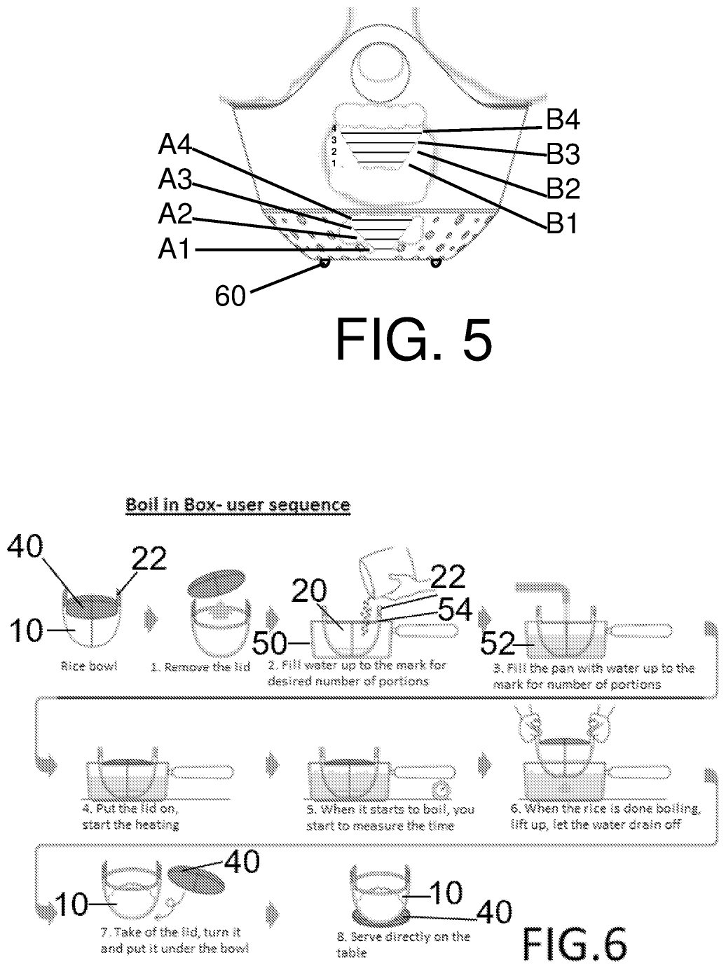

Reference is made to FIGS. 5 and 2, in which the side wall of the cup shows two sets of markings for the amount of rice (foodstuff) and water respectively.

Essentially, there are two ways to indicate amount of liquid and amount of foodstuff in the present invention. Preferably, the marks are formed as horizontal lines inside the cup wall, or they may be formed as holes or perforations.

In an alternative embodiment, the first set of markings encompasses that the cup wall of the lower part 26 is formed with a number of through-going holes or perforations A1, A2, A3, A4 in mutual parallel layers, such as in the form of a rows of holes. The holes are thus mutually spaced apart, and from below and up the holes in FIG. 2 are marked with A1, A2, A3, A4. The marks can be formed around the entire circumference of the cup or only around parts of the circumference of the cup. The purpose of these marks is that the user should be able to measure the amount of servings of foodstuff (rice) which shall be prepared by boiling in the cup with sufficient accuracy. Thus, the row of holes A1 corresponds to one serving, the row of holes A2 corresponds to two servings, the row of holes A3 corresponds to three servings while the row of holes A4 corresponds to four servings of rice, etc. The distance between each row of holes thus constitutes one normal serving of a particular foodstuff (such as rice).

The sets of marks can run through the cup wall mutually spaced apart around the entire circumference. Alternatively, a number of fewer sets that do not extend continuously can be arranged but placed in “smaller groups” over each quadrant around the circumference. Given that the marks are formed as holes, they preferably have a circular cross-section, although other cross-sectional shapes are also possible. The holes have a size that allows water to easily flow in and out of the inner volume of the cup while the foodstuff is kept immobilised inside the cup volume itself.

Assuming that the water volume for the cooking of rice is larger than the rice volume, the cup is comprised of a second set of measurement marks so that the user can choose the correct water level. In an alternative design, shown in FIG. 2, the base mark B1 marks the water amount for the corresponding single serving of rice, the mark B2 corresponds to the mark for two rice servings, the mark B3 corresponds to three rice servings while the row of holes B4 corresponds to four servings of rice. The ratio between the first set of marks A1-A4 for foodstuff and the second set of B1-B4 for liquid level is such that A1/B1=A2/B2=A3/B3=A4/B4 is constant.

These marks are also designed as holes through the cup wall. To clarify this, the lowest mark (one serving) B1 consists of one hole, the mark above B2 (two servings) consists of two holes, the mark above above there again B3 (three servings) consists of three holes and the mark at the top consists of four holes for four servings, etc. To visually link the marks to the understanding of water levels, each hole can be shaped like a tear drop, which also gives an additional appealing expression to the appearance of the cup. As the figures show, these four parallel rows of holes appear as a pyramid with its point facing down.

Alternatively, all of these four levels can be marked with the same number of holes through the cup wall, and numbers 1-2-3-4 engraved into the surface of the cup wall at each associated row of holes, as shown in FIG. 5. The surfaces both on the inside and outside of the cup can be comprised of such volume markings at the respective holes. The markings may be engraved or indented into the surface of the cup. When the cup is made of glass or plastic, it is transparent or translucent so that marks can easily be seen from both from the inside and outside of the cup.

As also can be seen in FIG. 2, the marks in the four heights for rice volume can also be marked with one hole at the bottom, then two holes in the next level, three holes in the next level and four holes at the top. I.e. they have the same visual expression as for the water level higher up on the side of the cup. Also, these holes can extend regularly around the circumference, or form smaller groups located around the circumference such as in each quadrant of the cup.

Corresponding alternative embodiments, as described above, are also possible if the markings are designed as horizontal lines rather than perforations as shown in FIG. 5.

Since the cup is intended to be placed into water in a pot with the lid applied, the water level will appear accurately both from the inside of the cup (before the lid is applied) and from its outside as a flat surface. This means that you do not need to visually assess the amount of water inside the cup to see when the amount of water is adjusted to the amount of rice. One can see from the outside of the cup how high up the water level is, indicated by the hole marks.

Because the cup has its own lid, you do not need a separate lid for the pot. By using the lid, you will be able to achieve a steaming/simmering function inside the cup.

The measurement marks for adding the amount of water are preferably designed as laser engraved marks on the inside and/or outside of the cup and shaped as lines with associated numbering for marking the number of servings such as 1-2-3-4 etc. placed in parallel above each other, see FIG. 5. In an alternative design, the marks are listed in an analogue manner, with the help of through running perforations or holes in the cup wall. The starting point may be a desired amount of water normally used to prepare a given amount of servings of rice, for example, in the ratio of 2:1, i.e. 2 volumes of water to 1 volume of rice.

Furthermore, for each mark, both for quantity of liquid and foodstuff, there may be engraved or indented additional serving marks, in the form of numbers or other appropriate symbols. These markings can be made both on the inside and on the outside of the cup wall. An example of such numbering is shown in FIG. 2. When the cup wall is comprised of a vertical narrow elongated slit instead of a number of separated marking holes, such numbering 1-2-3-4 as shown in FIG. 2 can be appropriate if the numbers are formed in a vertical line next to the slit. Although the invention is described for 1, 2, 3 and 4 servings, we would like to emphasize that the invention can also cover more than 4 servings, such as, for example, 5, 6, 7 or even more servings.

FIG. 3 shows the cup with the lid 40 attached. The lid has a shape similar to a dome with a flat top surface shown by 46 and is set up to be put on the cup between the handles 20, 22. The handles 20,22 are preferably projected vertically upwards and over the upper rim edge 54 of the pot 50 as shown in FIG. 5. When the lid 40 is turned and used as dish or bowl, as shown in FIG. 4, it stands firmly on the surface/table with its top side 46 facing downwards.

The cup is preferably made of steel, or of porcelain, plastic, or another metal. The holes are made during the casting/punching of the cup, but preferably as a final part of the production. The lid is preferably made of plastic, or of porcelain, steel or another metal. The combination of a cooking cup and a lid/plate makes up a serving set, as the main parts of a dishware which food is served in or on. In this case, the foodstuff is also heat-treated in the cup. Both parts of the cup and the lid/plate preferably have a harmonious design—such as colour combinations that give an appealing appearance.

In one embodiment, there may be several different sets of marks that provide the ratio of fluid level to foodstuff for different varieties of foodstuff. An example of this is one set of marks for foodstuff with a corresponding set of marks of liquid level markers for one type of food, such as rice, another set of marks for other foodstuffs, and associated set of marks for liquid level, such as quinoa, another set of marks for the number of servings of pasta and a corresponding set of marks for water levels for the preparation of oatmeal from oats etc. In a yet another possible embodiment method there can be many sets of marks for different foodstuffs and a common set of marks for liquid level where the liquid levels of the various foodstuffs are separated by different symbols, letters, colours or words. For example, the liquid level for a serving of rice may be marked “1 Rice”, the liquid level for a serving of pasta may be marked “1 Pasta” etc. There can also be different variants of the same foodstuff that are differentiated in this way, for example, brown rice, white rice, sushi rice etc.

The cup can be used for cooking/simmering foodstuff, especially rice, quinoa, oatmeal, pasta/spaghetti, vegetables and other foodstuffs intended for such cooking.

Preferably, the pot has an inner diameter which is somewhat larger than the outer diameter of the cup. Then the heat treatment process will consume an advantageous amount of liquid. The user can freely use a pot of any size given that the cup 10 fits into it. If a pot is used which is substantially larger than the outer diameter of the cup, the liquid consumption, and thus the energy consumption, will be greater than necessary when using the markings on the cup. In such cases, the consumer can experiment with a reduced amount of water. On the other hand, if you follow the markings for the liquid level in the cup this will ensure that you never have too little water for the cooking process.

### Cooking of Rice.

With reference to FIG. 6, the following operating instructions may be considered when a number (up to four in FIG. 6) of servings of rice are to be prepared using a pot with a lid according to the invention.

1) Remove the lid 40 from the cup 10

2) Fill the cup with rice up to the mark for the desired amount of foodstuff/rice servings and rinse thoroughly in cold water

3) Then put the cup down into the pot 50.

4) Fill the pot 50 with water 52 up to the mark for the number of servings.

5) Put the lid 40 (this step is optional) on and begin heating up

6) When water starts boiling, start the clock.

7) When the rice is cooked, the cup is lifted up from the pot 50 and any water may drain off.

8) Remove the lid 40 from the cup and turn it around and place it under the cup, for example, on the table, so that any dripping water remains on the bowl and not over for example a tablecloth.

9) Now the rice can be served and eaten directly from the cup.

The measurements of the required serving/amount of foodstuff can, of course, be done by using an external measuring cup where the foodstuff is poured into the cup, for example, the rice, is rinsed in cold running water and the container is placed in a pot, water is added to the indicated mark and the boiling starts.

When rice is prepared in a liquid such as water which is boiled, salt may be added to the water or other desired seasoning flavours such as spices and broth.

In addition to the fact that the cup with a lid can be used directly for cooking, it can also be used for steam cooking in a pot. The amount of water is then usually smaller, often covering only the bottom of the pot, and the foodstuff is steamed by the pure contact with the steam under the lid.

With this solution one has eliminated the disadvantages that exist with the usual way of boiling servings of rice in a measured amount of water used today. You do not have to burn your fingers from the plastic bag that has been lying in the boiling water, and there is no spillage of rice as with the known solution where when the bag is opened and the rice is squeezed out. In addition, one can use ordinary rice that is not pre-cooked, and which is less expensive than the “boil in bag” option.

1. A container for heat treatment of foodstuff in a liquid in a pot comprising:
a non-deformable cup (10) with a base and cup wall (24), wherein the cup wall (24) comprises:
through-going holes (70) for free flow of liquid into and out of the inner volume of the cup (10); and
at least one first set of marks identified as A1, A2, A3, and A4 and at least one second set of marks identified as B1, B2, B3, and B4; where
the at least one first set of marks is disposed on a lower part of the cup wall (24) to indicate levels for predetermined volumes of a foodstuff in the cup (10),
the at least one second set of marks is disposed above the at least one first set of marks, wherein each of the at least one second set of marks B1, B2, B3, and B4 indicates an in-cup level of added liquid required for the heat treatment of the volume of the foodstuff indicated by each of the at least one first set of marks A1, A2, A3, and A4, respectively, wherein
ratios of the volumes of the foodstuff represented by the at least one first set of marks to volumes of the liquid represented by the at least one second set of marks, defined respectively as A1/B1, A2/B2, A3/B3, and A4/B4, are predetermined based on the type of foodstuff that is to be heat-treated.

2. The container of claim 1, wherein:
the individual marks A1, A2, A3, and A4 of the at least one first set of marks are mutually spaced apart on the cup wall (24), so that a first mark A1 of the at least one first set of marks indicates the level of one normal serving of the foodstuff in the cup (10), a second mark A2 of the at least one first set of marks indicates the level of two normal servings of the foodstuff in the cup (10), a third mark A3 of the at least one first set of marks indicates the level of three normal servings of the foodstuff in the cup (10), and a fourth mark A4 of the at least one first set of marks indicates the level of four normal servings of the foodstuff in the cup (10); and wherein
the individual marks B1, B2, B3, and B4 of the at least one second set of marks are mutually spaced apart on the cup wall (24), so that a first mark B1 of the at least one second set of marks indicates the required liquid level for heat treatment of one normal serving of the foodstuff in the cup (10), a second mark B2 of the at least one second set of marks indicates the required liquid level for heat treatment of two normal servings of the foodstuff in the cup (10), a third mark B3 of the at least one second set of marks indicates the required liquid level for heat treatment of three normal servings of the foodstuff in the cup (10), and a fourth mark B4 of the at least one second set of marks indicates the required liquid level for heat treatment of four normal servings of the foodstuff in the cup (10).

3. The container of claim 1, wherein:
the ratios A1/B1, A2/B2, A3/B3, and A4/B4 have the same constant value so that A1/B1=A2/B2=A3/B3=A4/B4, wherein the constant value is predetermined based on the type of foodstuff that is to be heat-treated.

4. The container of claim 3, wherein:
when the cup (10) is used to heat rice, the ratio A1/B1=A2/B2=A3/B3=A4/B4 is approximately equal to 0.5 so that the volume of rice is approximately half that of the volume of water.

5. The container of claim 1, wherein:
the at least one first set of marks and the at least one second set of marks are either engraved marks or indented marks such as straight horizontal lines in the cup wall or are formed by sets of holes through the cup wall.

6. The container of claim 1, wherein:
the at least one first set of marks comprises a plurality of first sets of marks; wherein
each first set of marks of the plurality of first sets of marks is formed by a first set of holes disposed through and mutually spaced apart along the cup wall (24), so that;
each first mark A1 of each first set of marks comprises at least one hole and indicates the level of one normal serving of the foodstuff in the cup (10), each second mark A2 of each first set of marks comprises at least one hole and indicates the level of two normal servings of the foodstuff in the cup (10), each third mark A3 of each first set of marks comprises at least one hole and indicates the level of three normal servings of the foodstuff in the cup (10), and each fourth mark A4 of each first set of marks comprises at least one hole and indicates the level of four normal servings of the foodstuff in the cup (10).

7. The container of claim 6, wherein:
each first mark A1 of each first set of marks comprises one hole;
each second mark A2 of each first set of marks comprises two holes;
each third mark A3 of each first set of marks comprises three holes; and
each fourth mark A4 of each first set of marks comprises four holes; wherein
each hole has a circular, triangular, square, oval or teardrop-shaped cross-section, or it is in the form of an elongated slit.

8. The container of claim 1, wherein:
the at least one second set of marks comprises a plurality of second sets of marks; wherein
each second set of marks of the plurality of second sets of marks is formed by a second set of holes disposed through and mutually spaced apart along the cup wall (24), so that;
each first mark B1 of each second set of marks comprises at least one hole and indicates the required liquid level for heat treatment of one normal serving of the foodstuff in the cup (10), each second mark B2 of each second set of marks comprises at least one hole and indicates the required liquid level for heat treatment of two normal servings of the foodstuff in the cup (10), each third mark B3 of each second set of marks comprises at least one hole and indicates the required liquid level for heat treatment of three normal servings of the foodstuff in the cup (10), and each fourth mark B4 of each second set of marks comprises at least one hole and indicates the required liquid level for heat treatment of four normal servings of the foodstuff in the cup (10).

9. The container of claim 8, wherein:
each first mark B1 of each second set of marks comprises one hole;
each second mark B2 of each second set of marks comprises two holes;
each third mark B3 of each second set of marks comprises three holes; and
each fourth mark B4 of each second set of marks comprises four holes; wherein
each hole has a circular, triangular, square, oval or teardrop-shaped cross section, or it is in the shape of an elongated slit.

10. The container of claim 1, wherein:
the at least one first set of marks comprises more than two first sets of marks, and the at least one second set of marks comprises more than two second sets of marks; and
the more than two first sets of marks are arranged mutually spaced apart along the circumference of the cup (10), and the more than two second sets of marks are arranged mutually spaced apart along the circumference of the cup (10).

11. The container of claim 1, wherein:
the at least one first set of marks comprises a plurality of first sets of marks; and
the at least one second set of marks comprises a plurality of second sets of marks; wherein
each of the plurality of first sets of marks is associated in regard to a particular type of the foodstuff with each of the plurality of second sets of marks so that for the particular type of the foodstuff the associated first set of marks indicates levels for predetermined volumes of the particular type of the foodstuff in the cup (10), and the associated second set of marks indicates in-cup levels of added liquid required for the heat treatment of the predetermined volumes of the particular type of the foodstuff; and wherein
the particular type of the foodstuff is selected from the group of foodstuffs consisting of rice, oats (oatmeal), pasta, quinoa, brown rice, sushi rice, and white rice; wherein
the plurality of first sets of marks and the associated plurality of second sets of marks are arranged mutually spaced apart around the circumference of the cup.

12. The container of claim 1, wherein:
the cup (10) is comprised of a detachable curved lid (40) with a flat upper side (46), where the lid turned upside down provides a stable base for the cup (10) to be placed on after the heat treatment or as a serving plate for the foodstuff.

13. The container of claim 1, wherein:
the cup (10) is comprised of a base with one or more spacers (60) below the base to keep the underside of the cup at a proper distance above the base of the pot.

14. The container of claim 1, wherein:
adjacent to individual marks of each of the at least one first set of marks and individual marks of each of the at least one second set of marks there is engraved or indented further serving markings on the outside and/or inside of the cup wall (24) in the form of numbers or symbols.

15. The container of claim 1, wherein:
the cup wall is comprised of at least one upwardly extending gripping handle (20/22) for manually guiding the cup (10) down into and up from the pot in which the heat treatment is performed.

16. The container of claim 1, wherein:
the cup (10) is made of a transparent or translucent material such as plastic or glass, so that the markings are visible through the cup wall (24).

17. A method of cooking/simmering rice by using the container of claim 1, the method comprising the steps of:
1) filling the rice into the cup (10) up to an individual mark of the at least one first set of marks for the desired number of servings;
2) rinsing the rice thoroughly in cold water before the cup (10) is placed in the pot which holds the cup (10);
3) filling the pot with water up to an individual mark of the at least one second set of marks corresponding to the number of servings;
4) placing a lid on the cup (10) and the warming up starts;
5) when the rice is cooked, lifting the cup (10) up from the pot and allowing any water to drain off;
6) removing the lid from the cup (10), turning the lid over and placing the cup (10) on the lid; and
7) serving the rice directly from the cup (10).
